(19) United States
(12) Patent Application Publication
(10) Pub. No.: US 2014/0157545 A1
(43) Pub. Date: Jun. 12, 2014

(54) ROLLO-FLEX ASSEMBLY

(71) Applicant: Enzo Maola, Windsor (CA)

(72) Inventor: Enzo Maola, Windsor (CA)

(21) Appl. No.: 14/086,274

(22) Filed: Nov. 21, 2013

Related U.S. Application Data
(60) Provisional application No. 61/734,029, filed on Dec. 6, 2012.

(51) Int. Cl. E05D 15/00; E05D 15/06; E05D 13/00; E05D 15/16

(52) U.S. Cl. CPC E05D 15/00; E05D 15/165; E05D 15/0621; E05D 13/00
USPC 16/91

(57) ABSTRACT

A rolling mechanism encompassing various sets of Rollo-flex assemblies, as defined in the specification, within a customer supplied track, inside a retractable truck tarpaulin system and rolling and sliding doors. The invention improves on single roller and wheels presently used in retractable tarp system and rolling doors, particularly in moving vehicles by providing substantial savings over current systems, ensuring longer service life, providing a stronger and more stable covering system while protecting the wheels and rollers from the shock loads of road travel.

### CROSS REFERENCE TO RELATED APPLICATION

This non-provisional patent application is directly related to the provisional application No. 61/734,029 filed on Dec. 6, 2012.

### STATEMENT REGARDING FEDERALLY SPONSORED RESEARCH OR DEVELOPMENT

Not Applicable

### BACKGROUND OF THE INVENTION

This invention pertains to retractable tarpaulin systems, rolling, and sliding doors, particularly of moving vehicles, which utilize single rollers and single wheels inside tracks.

### BRIEF SUMMARY OF THE INVENTION

Roller(s) FIG. 1 Element 1 designed to roll while carrying the intended component weights without flexing or deflecting during the opening and closing operation; will then flex or deflect, a predetermined amount, when subjected to heavier shock loads sustained during road travel. Whereas such roller(s), are set inside an impact resisting housing block, FIG. 1 Element 2, and whereas the impact block, can sustain the heavier shock loads encountered in road travel. Therefore, two sets of rollers or wheels, fitting snugly in a track of retractable tarpaulins of trucks or rolling and sliding doors, will be saved from the shock loads of road travel and can perform their intended rolling function of opening and closing the tarpaulins and doors without damage to the rollers.

### BRIEF DESCRIPTION OF THE SEVERAL VIEWS OF THE DRAWING

FIG. 1—This drawing depicts the Rollo-flex assembly with all parts of invention.

FIG. 2—Depiction of FIG. 1 inside of track.

FIG. 3—The drawing is a representation of FIG. 1 utilizing two different sized Rollo-flex Assemblies and the corresponding track where assemblies are housed.

FIG. 4—A lateral view of FIG. 3.

FIG. 5—A potential application utilizing railroad track designs.

### DETAILED DESCRIPTION OF THE INVENTION

### Purpose

Rollers used on current rolling and sliding doors and retractable tarpaulin systems for the trucking industry, suffer from damage and untimely failure as a result of forces, such as vibrations, shock, bounce and air friction forces incurred during road travel. Single rollers require play in the track which during road travel, increases the gravitational forces on the system and consequently the failure rate. Play also causes misalignment in the track which prevents the smooth rolling for opening and closing. This invention eliminates play by utilizing a zero clearance rolling mechanism within a shock resistant roller housing to protect the rollers from the rigors of road travel.

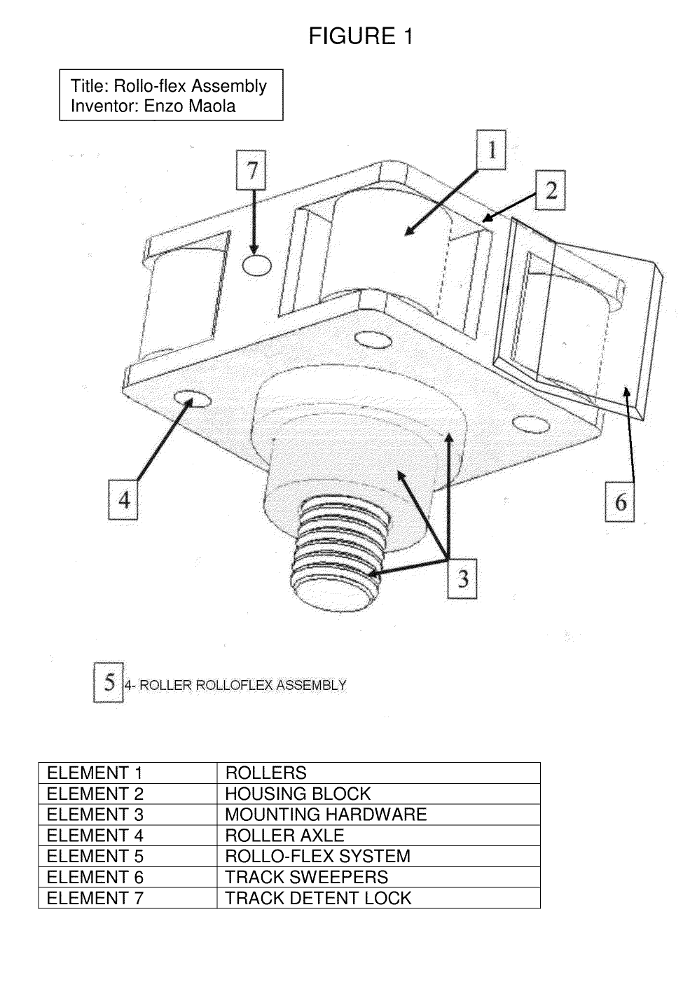

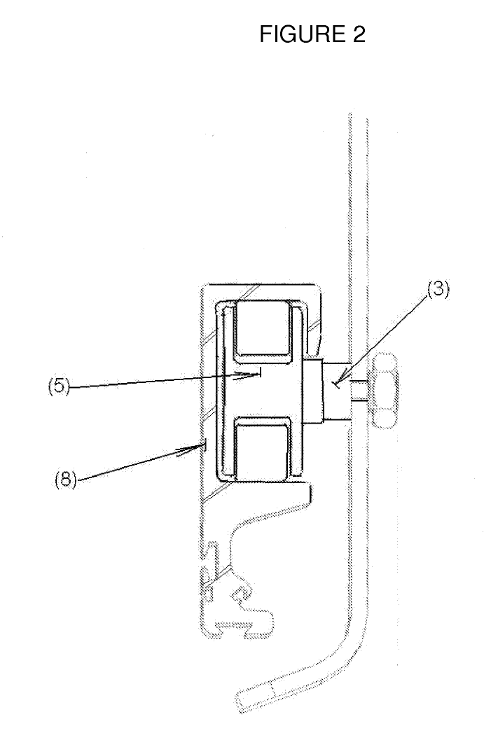

This roller system, FIG. 1 Element 5, utilizes two sets of rollers FIG. 1 Element 1, within a protective housing block FIG. 1 Element 2. Both sets of rollers are made to contact both sides of the track FIG. 2 Element 8, so as to roll independently and in opposite directions. This eliminates the need for play. When excessive forces are exerted on the system, the rollers are allowed to depress slightly without damage. The protective housing restricts the amount of roller depression and supports the heavy loads that would otherwise damage the rollers. The protective housing also provides system stability during road travel. Track sweepers FIG. 1 Element 6, located directly in front of each roller, clear out any debris that may rest on the track and possibly impede rolling. This system; hereinafter, shall be referred to as Rollo-flex FIG. 1 Element 5.

### Improvement on Other Systems

The Rollo-flex System utilizes an integrated design that involves one or a multiplicity of rollers mounted inside of a protective shock resisting roller housing. The system does not require play in the track. The absence of play reduces rattles and bounces and the resultant gravitational force loads that would otherwise damage the rollers. Roller misalignment in the track and the resultant drag and chatter that play would cause, is prevented. This invention therefore, specifically provides a) smoother operation during opening and closing b) reduces noise, rattles, and c) provides longer service life.

Current designs use single rollers. These, requires play between moving roller components and the stationary track component. The play which is inherent in the single roller design contributes to three problems: a) chatter and binding inside the track during opening and closing operation; b) high noise levels during over the road travel and c) short service life due to accelerated wear of critical components that results from amplification of forces during road travel.

The rollers in current designs ride directly in a track without shock shielding. Clearance between the roller and track is required to permit rotation. This creates three weaknesses. a) The play permits degrees of roller misalignment left and right in the track which can lead to chatter and binding during opening and closing operation. b) The play also permits roller oscillation up and down and side to side in the track which creates excessive noise during over the road operation. c) The up and down and side to side motion magnifies loads incurred by the rollers during over the road operation. The high loads accelerate wear on the critical moving roller components.

The Rollo-flex System, FIG. 1, is an integrated design that incorporates one or more rollers mounted in a flexible shock absorbing roller housing system. The addition of rollers in the housing increases load bearing capacity. It can incorporate an integral wiper in front of each roller that prevents the build up of road grime and debris in the track. This results in longer system service life and smooth trouble free operation during opening and closing. The system is also quieter than current systems during over the road operation as it's installed without play in the track.

### PARTS COMPRISING THE INVENTION

See FIG. 1 for Reference

Item #1 Roller

Item #2 Roller Housing Block

Item #3 Mounting Hardware

Item #4 Roller Axle

Item #5 Rollo-flex System

Item #6 Track sweepers (depends on application)

Item #7 Track Detent Lock (optional)

### RELATED PARTS

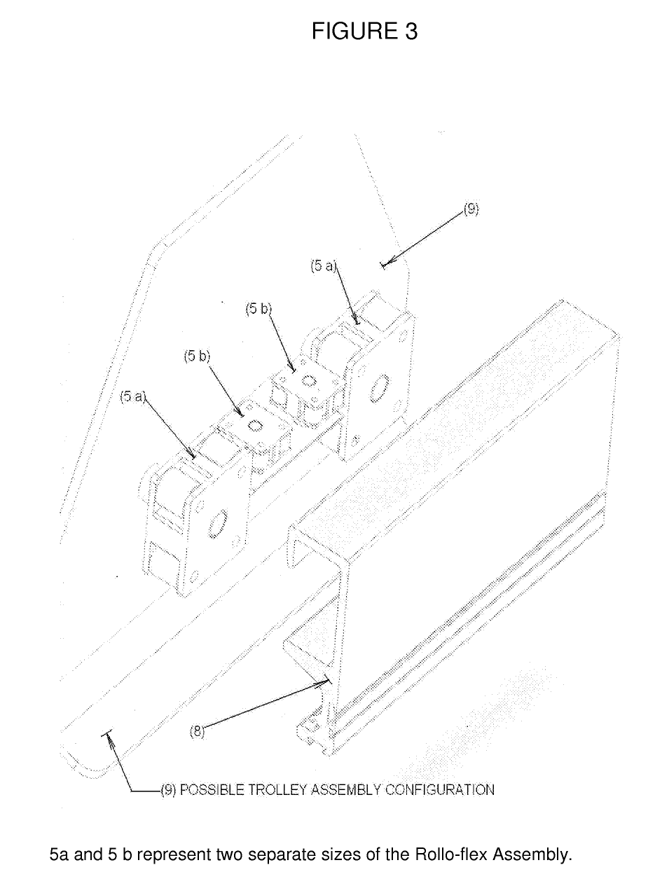

Item #8 Track (to suit applications) See FIG. 3

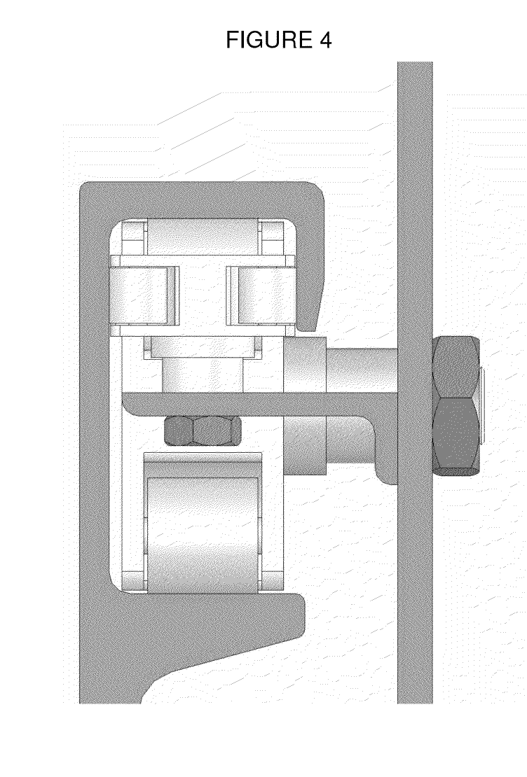

Item #9 Trolley Assembly (Example configuration) See FIG. 4

### Relationship Between Components

See FIG. 1 for corresponding elements. Rollers, Axles, Track sweeper and Mounting Hardware are installed in the Roller Protective Housing to create the Rollo-flex System.

The Rollo-flex System is attached to table or chair legs, truck doors or tarpaulin retraction systems by the mounting hardware. The track sweepers are also attached to the roller housing and protective block in front of each roller that ride on tracks to clear out debris.

### How it Works?

This invention, when used on trucks with a retractable tarpaulin system, is designed to fit the appropriate track with zero clearance between the wheels and the track. Two sets of rollers contact both sides of the track and can rotate independently and in opposite directions for the opening and closing operation. During road travel, the protective roller housing, together with rollers, rest motionless in the track preventing noise and rattles. The protective housing block stops the excessive forces of road travel, as well as, providing greater overall system stability. This is an integrated unit. Its designed to ride on its rollers in the truck's door track or tarpaulin track with snug clearance to maintain alignment in the track during opening and closing and minimize oscillating motion in the track during road travel. The rollers are designed to flex and absorb the motion forces generated by road travel. The roller housing is designed to absorb greater forces that exceed the design limit of the rollers. The system provides long service life and protection from failure.

For added stability, the Rollo-flex can be equipped with a detent mechanism or a brake device, FIG. 1 Element 7, so that it can be engaged during road travel to further reduce shock and vibrations and increase total system stability.

### How it's Made

The Rollo-flex system is designed for ease of manufacture and assembly as an integrated unit. The key to cost effectiveness is a one step molding process that permits streamlined assembly. The plastic and or metal used for the various components prevent the use of lubricants as well as rust and corrosion. Rollo-flex units will be produced in various configurations and will be field tested for their specific intended applications.

The Rollo-flex system is an integrated and modular design. The base configuration for track systems includes; 4 rollers, 1 roller housing, 4 roller axles and 1 mounting bolt. The system can be expanded as demand requires to any size or configuration of rollers, from 1 roller as in a simple caster for chairs, to an infinite number of rollers to increase weight bearing requirements. The Rollo-flex can be configured to contact either side of the track with any number of rollers as deemed necessary for each specific application. Also mounting hardware of various kinds is used to suit the application. For additional system stability a braking or indexing device can be fitted so as to hold the tarpaulin stationary on the track after it has been tensioned for road travel. The roller components can also be used as casters for chairs and carts in single or multiple roller configurations depending on weight bearing requirements.

For track applications requiring additional weight bearing capacity roller housing assemblies of more than four rollers can be produced. It can also be reconfigured to function as casters for chairs or carts. For caster applications, the rollers or wheels are set inside a protective housing which is designed to support heavy loads. The wheels or rollers are spring loaded in order to roll freely when the load is relieved.

### How it's Used

The Rollo-flex System is designed for two purposes. It can be used as a system component for new truck trailer doors or new retracting tarpaulin installations and new casters for chairs and carts. The Rollo-flex System can also be used to retrofit casters on chairs and carts as well as in service doors and tarpaulin assemblies to gain the advantages of reliable operation, reduced noise and longer service life. Systems, utilizing caster type applications, can also be used in new or retrofit applications.

### Other Uses

The multi-roller configurations are designed with two sets of rollers primarily for sliding or overhead truck doors and retracting truck tarpaulin covers. Either roller set can contain any number of rollers to satisfy the weight bearing capacity of each application. The shock absorbing and variable weight bearing capacity of the system is valuable primarily in moving vehicles where varying conditions of over the road motion subjects systems to large force loads. The caster type Rollo-flex can be configured for chairs or carts and can also be made with a single roller.

1. A roller system, FIG. 1 Element 5, composed of one or more rollers, rolling freely while carrying the intended load in which the rollers are protected from excessive loads that result from inertia forces of wind rattle and bounce, developed during travel.

2. The system in claim 1 having two sets of rollers. The rollers contact both sides of the track without play. The absence of play prevents misalignment and road bounce.

3. The roller system of claim 1 comprising: four rollers FIG. 1 Element 1, roller housing FIG. 1 Element 2, roller axels FIG. 1 Element 3, where the roller housing is rectangular and the rollers are placed at each corner and protruding there from a predetermined amount, so as creating two pairs regardless of orientation, which as a result of the rectangular design, can be installed in two differently sized tracks.

4. The roller system of claim (3) further comprising: a detent lock or brake, FIG. 1 Element 7 which is engaged during road travel, to further protect rollers from excessive inertia forces.

5. The roller system of claim (3) further comprising: a track sweeper, FIG. 1 Element 6 to prevent accumulation of debris on the rollers during opening and closing.

6. Roller systems of claim (1) for track use, contains two sets of rollers. Either set contains one or a multitude of rollers so as to vary load bearing requirements to suit application.

7. A single or multiple roller system of claim (1) set in a protective housing comprises a caster used in chairs or in heavy work benches.

8. The roller system of claim 1 through 7 comprising components of plastic and or metal, in combination eliminating the need for utilizing lubricants.

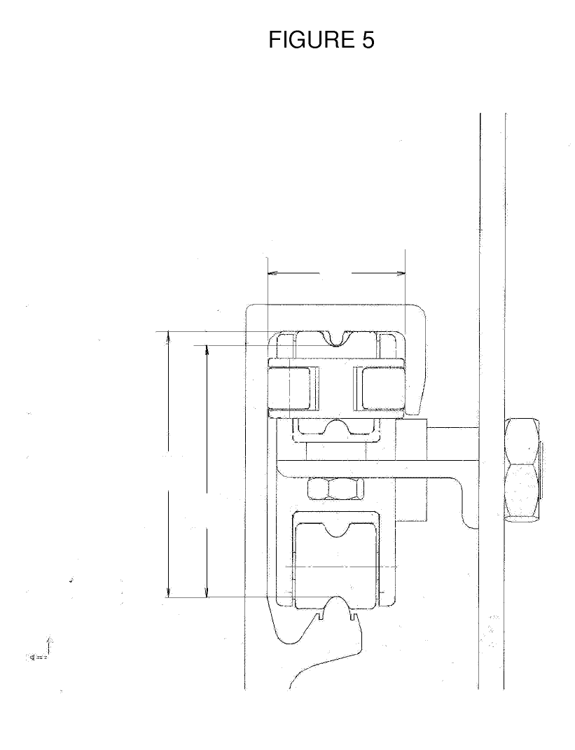

9. The roller system of claim 1 through claim 6, where the contact circumference of the rollers is grooved or formed to fit over, roll on and over tracks with a aptly corresponding shape. Such tracks shall be made to function the same or similar to a rail road track and where the rollers shall be made to function the same or similar to train rollers or wheels. The rail road style tracks are grooved instead and the rollers or wheels are made to fit and roll in and over the grooved rail road style track. FIG. 5
